(19) United States
(12) Patent Application Publication
(10) Pub. No.: US 2014/0130095 A1
(43) Pub. Date: May 8, 2014

(54) METHOD AND SYSTEM FOR PROVIDING ELECTRONIC PERSONALIZED MENU

(71) Applicant: CHUNGHWA WIDEBAND BEST NETWORK CO., LTD., New Taipei City (TW)

(72) Inventor: Alan Chen, New Taipei City (TW)

(73) Assignee: CHUNGHWA WIDEBAND BEST NETWORK CO., LTD., New Taipei City (TW)

(21) Appl. No.: 13/855,205

(22) Filed: Apr. 2, 2013

(30) Foreign Application Priority Data
Nov. 6, 2012 (TW) 101141207

(51) Int. Cl. H04N 21/482

(52) U.S. Cl. CPC H04N 21/482
USPC 725/46

(57) ABSTRACT

The present invention provides a machine-implemented method of displaying an electronic personalized menu applied for a multimedia system, wherein the multimedia system provides a plurality of services for one or more users, wherein each of the plurality of services includes one or more service options/items, and the multimedia system comprises a sever, the method comprising: detecting recognition data corresponding to the one or more users and recognizing the identity and number of the one or more users by a recognition method; automatically logging into a personal or group account based on the identity and number of the one or more users and then the sever recording use habits of the one or more users of the personal or group account; and displaying an electronic personalized menu of the personal or group account based on the use habits recorded.

### FIELD OF THE INVENTION

The present invention pertains to an electronic personalized menu display method and a multimedia system thereof.

### BACKGROUND OF THE INVENTION

With the development of the technology internet and mobile device, people can watch favorite video program, do recreational activities, or handle financial affair at any time; it is accomplished through service websites on internet for watching TV program, movie, drama and cartoon, reading news, searching information, doing exercise, singing karaoke, teaching activity, even financial analysis, shopping, and financial management.

However, services on each website are limited to a specific functionality. For instance, online TV websites provide only video-watching services; internet banks provide only financial services; and shopping websites provide only online shopping services. If a user would like to do multiple activities, it will be time-consuming to search among websites one by one and enter websites through different webpages and interfaces. In addition, the user has to pay for services through operation procedure and charge mechanism on each website respectively, which generate risk on financial transactions and inconvenience in account management, and thereby steps back in view of the unclearness of the operation procedure.

Thus, this is how multimedia system came into being, with various functionalities and services integrated therein. However, the menu of a multimedia system is commonly complex and bulky, and the user needs to spend additional time to search and obtain a functionality or service. Electronic personalized menu can solve this problem, allowing the user to easily find and select specific service options. However, for a multimedia system in the prior art, the user have to manually enter login information and manually add specific service options into electronic personalized menu (e.g. the favorites folder), or the multimedia system simply remember several services which are used the most. It is inconvenient to manually operate and unable to provide an electronic personalized menu reflecting the use habits of one or more users.

Therefore, there is still a need for an improved method and a multimedia system of displaying an electronic personalized menu in accordance with the use habits of personal or group users with more convenient operation and humanity.

### BRIEF SUMMARY OF THE INVENTION

Accordingly, the present invention provides a machine-implemented method and a multimedia system of displaying an electronic personalized menu in accordance with the use habits of personal or group users with easier and intelligent login.

In one aspect, the present invention provides a machine-implemented method of displaying an electronic personalized menu applied for a multimedia system, wherein the multimedia system provides a plurality of services for one or more users, wherein each of the plurality of services includes one or more service options/items, and the multimedia system comprises a sever, the method comprising: detecting recognition data corresponding to the one or more users and recognizing the identity and number of the one or more users by a recognition method; automatically logging into a personal or group account based on the identity and number of the one or more users and then the sever recording use habits of the one or more users of the personal or group account; and displaying an electronic personalized menu of the personal or group account based on the use habits recorded.

The electronic personalized menu presents one or more service items sorted according to use frequency of the one or more service options/items in a recent period of time. The electronic personalized menu also presents one or more recommended service options/items or advertisements based on the use habits recorded.

The recognition method is selected from the group consisting of image recognition, iris recognition, voiceprint recognition, fingerprint recognition, and a combination thereof.

In one embodiment of the present invention, the multimedia system provides k services having Nₖ orders of service options respectively, wherein there are one or more n^{th} order service items and/or one or more n+1^{th} order service options under a n^{th} order service option of the Nₖ orders of service options, wherein n is a natural number and 1≦n≦N^{k}, the method comprising: recording the one or more users' use frequency of each n^{th} order service option and item in a recent period of time, wherein n is a natural number and 1≦n≦N^{k}; and presenting to the one or more users a n^{th} order menu of a service, the n^{th} order menu comprising: (i) one or more n^{th} order service items and/or one or more n+1^{th} order service options of the service which are sorted according to the use frequency thereof, wherein a n+1^{th} order service menu is presented when a n+1^{th} order service option is selected; or (ii) one or more n+1^{th} order service items of one or more n+1^{th} order service options of the service, wherein the one or more n+1^{th} order items are sorted according to the use frequency thereof, wherein n is a natural number and 1≦n<N^{k}; wherein k and N^{k} are natural numbers and k>N^{k}≧1.

In another aspect, the present invention provides a multimedia system for displaying an electronic personalized menu, wherein the multimedia system provides a plurality of services for one or more users, wherein each of the plurality of services includes one or more service options/items, the multimedia system comprising: a recognition data detection module for detecting a recognition data for recognition of the identity and number of the one or more user, the recognition data detection module being able to communicate with the below mentioned mediation module; a server unit configured to, upon execution of computer readable instructions: automatically logging into a personal or group account based on the identity and number of the one or more users; recording use habits of the one or more users of the personal or group account; and generating an electronic personalized menu of the personal or group account based on the use habits recorded; a display device for displaying the plurality of services and the electronic personalized menu; a mediation module connected between the display device and the server unit; and a remote control module for inputting instructions to the mediation module; wherein the recognition data is processed by the mediation module and then transmits to the sever unit for certification and automatic recognition of the identity and number of the one or more users by a recognition method.

The recognition data detection module may integrate with the display device, the mediation module, or the remote control module. In one embodiment of the present invention, after preliminary recognition of a recognition data, the recognition data is transmitted, by the mediation module, to the server unit for recognition of the identity and number of one or more users.

The mediation module may be a set-up box, a universal serial bus (USB) device, or a mobile device.

It is believed that without further explanation, persons skilled in the art can still apply the present invention to its widest scope based on the descriptions herein. Therefore, the descriptions below should be treated as merely explanations but not restrictions to the scope of the present invention in any way.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow diagram of an electronic personalized menu display method according to one embodiment of the present invention.

FIG. 2 is a diagram illustrating a multimedia system of displaying an electronic personalized menu according to one preferred embodiment of the present invention.

### DETAILED DESCRIPTION OF THE INVENTION

Unless defined otherwise, all technical and scientific terms used herein have the same meaning as commonly understood by a person skilled in the art to which this invention belongs.

As used herein, the singular forms “a”, “an”, and “the” include plural referents unless the context clearly dictates otherwise. Thus, for example, reference to “a sample” includes a plurality of such samples and equivalents thereof known to those skilled in the art.

In one aspect, the present invention provides a machine-implemented method of displaying an electronic personalized menu applied for a multimedia system, wherein the multimedia system provides a plurality of services for one or more users, wherein each of the plurality of services includes one or more service options/items, and the multimedia system comprises a sever, the method comprising: detecting recognition data corresponding to the one or more users and recognizing the identity and number of the one or more users by a recognition method; automatically logging into a personal or group account based on the identity and number of the one or more users and then the sever recording use habits of the one or more users of the personal or group account; and displaying an electronic personalized menu of the personal or group account based on the use habits recorded.

Based on the use habits recorded by the server unit, a method of the present invention displays various electronic personalized menu in accordance with the use habits of personal or group users.

In certain embodiments of the present invention, the electronic personalized menu presents one or more service items sorted according to use frequency of the one or more service options/items in a recent period of time, wherein the recent period of time may adjust based on use habits, i.e. the recent period of time may be between one to ninety days. According to one embodiment of the present invention, the recent period of time is thirty days.

In another embodiment, the electronic personalized menu further provides one or more recommended service options/items or advertisements based on the use habits recorded.

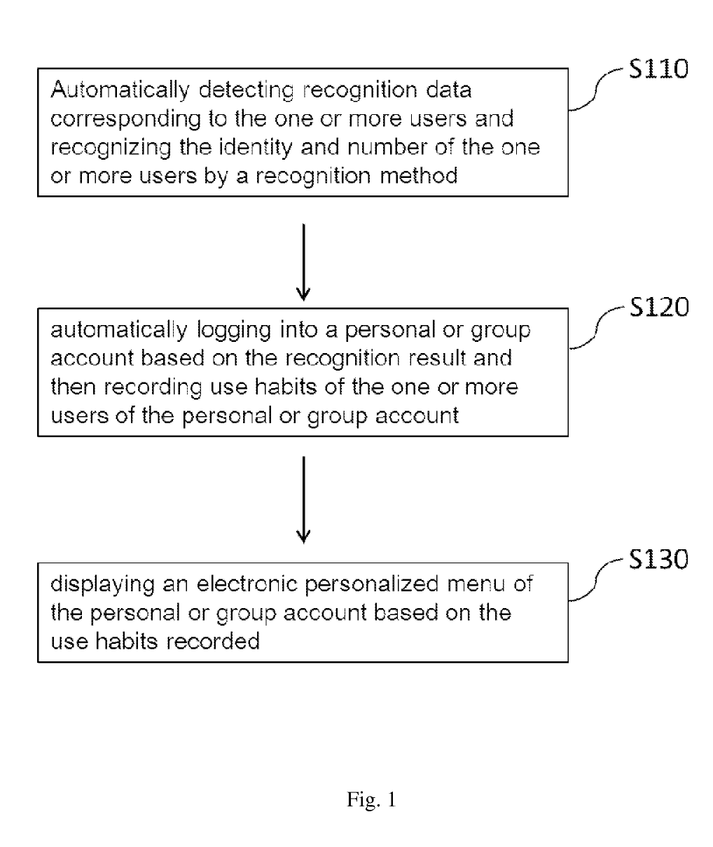

As shown in FIG. 1, a method of the present invention comprises the step of: automatically detecting recognition data corresponding to the one or more users and recognizing the identity and number of the one or more users by a recognition method (Step S110); automatically logging into a personal or group account based on the recognition result and then recording use habits of the one or more users of the personal or group account (Step S120); and displaying an electronic personalized menu of the personal or group account based on the use habits recorded (Step S130).

The term “recognition method” as used herein refers to any known method in the art that may be used for recognizing the identity and number of people. For example, a recognition method may be selected from the group consisting of an image recognition method, an iris recognition method, a voiceprint recognition method, a fingerprint recognition method, and a combination thereof. A recognition data varies based on different recognition methods, including but not limited to a video, a fingerprint, or a voiceprint.

According to one embodiment of the present invention, the item presented in the electronic personalized menu is selected from the group consisting of personalized channels, personalized movies, personalized albums, personalized guestbooks, personalized internet videos, and a combination thereof.

In one embodiment of the present invention, the multimedia system provides k services having Nₖ orders of service options respectively, wherein there are one or more n^{th} order service items and/or one or more n+1^{th} order service options under a n^{th} order service option of the Nₖ orders of service options, wherein n is a natural number and 1≦n≦N^{k}, the method comprising: recording the one or more users' use frequency of each n^{th} order service option and item in a recent period of time, wherein n is a natural number and 1≦n≦N^{k}; and presenting to the one or more users a n^{th} order menu of a service, the n^{th} order menu comprising: (i) one or more n^{th} order service items and/or one or more n+1^{th} order service options of the service which are sorted according to the use frequency thereof, wherein a n+1^{th} order service menu is presented when a n+1^{th} order service option is selected; or (ii) one or more n+1^{th} order service items of one or more n+1^{th} order service options of the service, wherein the one or more n+1^{th} order items are sorted according to the use frequency thereof, wherein n is a natural number and 1≦n<N^{k}; wherein k and N^{k} are natural numbers and k>N^{k}≧1.

According to one embodiment of the present invention, the n+1^{th} order menu comprises: (i) one or more n+1^{th} order service items and/or one or more n+2^{th} order service options of the service which are sorted according to the use frequency thereof, wherein a n+2^{th} order service menu is presented when a n+2^{th} order service option is selected; or (ii) one or more n+2^{th} order service items of one or more n+2^{th} order service options of the service, wherein the one or more n+2^{th} order items are sorted according to the use frequency thereof, wherein n is a natural number and 1≦n<N^{k}−1.

In another embodiment of the present invention, when the service is a TV program service, a 1^{st} order menu of the service may be presented, the 1^{st} order menu comprising one or more 2^{nd} order service options which are sorted according to the use frequency thereof, wherein a 2^{nd} order menu is presented when a 2^{nd} order service option is selected.

According to one embodiment of the present invention, the one or more 2^{nd} order service options are selected from the group consisting of news program, featured program, entertainment program, sport program, religion program, live program, worldwide program, digital broadcast TV program, drama program, movie, political program, health program, science program, education program, culture program, food program, travel program, art program, music program, and a combination thereof.

According to the present invention, the service options of the multimedia system are selected from the group consisting of TV program, video broadcasting, puzzle games, life information, financial business, personal zone, karaoke, TV shopping, voice communication, and a combination thereof.

In one embodiment of the present invention, the one or more service options/items in the multimedia system are presented in a menu in the form of a square or rectangular array, e.g. a 3-by-3 square array or a 4-by-3 rectangular array.

In another aspect, the present invention provides a multimedia system for displaying an electronic personalized menu, wherein the multimedia system provides a plurality of services for one or more users, wherein each of the plurality of services includes one or more service options/items, the multimedia system comprising: a recognition data detection module for detecting a recognition data for recognition of the identity and number of the one or more user, the recognition data detection module being able to communicate with the below mentioned mediation module; a server unit configured to, upon execution of computer readable instructions: automatically logging into a personal or group account based on the identity and number of the one or more users; recording use habits of the one or more users of the personal or group account; and generating an electronic personalized menu of the personal or group account based on the use habits recorded; a display device for displaying the plurality of services and the electronic personalized menu; a mediation module connected between the display device and the server unit; and a remote control module for inputting instructions to the mediation module; wherein the recognition data is processed by the mediation module and then transmits to the sever unit for certification and automatic recognition of the identity and number of the one or more users by a recognition method.

According to the present invention, the recognition method refers to any known method in the art that may be used for recognizing the identity and number of people. For example, a recognition method may be selected from the group consisting of an image recognition method, an iris recognition method, a voiceprint recognition method, a fingerprint recognition method, and a combination thereof. A recognition data varies based on different recognition methods, including but not limited to a video, a fingerprint, or a voiceprint.

Therefore, the recognition data detection module refers to any detection module that may be used for detection of recognition data for recognizing the identity and number of people. For example, in terms of image recognition, the recognition data detection module may be a camera; in terms of fingerprint recognition, the recognition data detection module may be a fingerprint sensitization/detection device. The recognition data detection module may be integrated with the display device, the mediation module, or the remote control module. For example, the fingerprint sensitization/detection device may be integrated with the remote control module.

In one embodiment of the present invention, after preliminary processed of the recognition data by the mediation module, the recognition data is transmitted, by the mediation module, to the server unit for recognition of the identity and number of the one or more users.

Based on the use habits recorded by the server unit, the multimedia system of the present invention displays various electronic personalized menu in accordance with the use habits of personal or group users.

In one embodiment of the present invention, the server unit provides an electronic personalized menu according to use frequency of the one or more service options/items in a recent period of time. For example, the electronic personalized menu presents one or more service items sorted according to use frequency of the one or more service options/items in a recent period of time, wherein the recent period of time may adjust based on use habits, for example, the recent period of time may be between one to ninety days. According to one embodiment of the present invention, the recent period of time is thirty days.

According to one embodiment of the present invention, the mediation module is a set-up box, a universal serial bus (USB) device, or a mobile device.

According to the present invention, the mediation module may communicate with the server unit through internet. In one embodiment of the present invention, the mediation module may communicate with the sever unit via optical fiber networks, telephone data lines, wireless fidelity (Wi-Fi), 3.5G mobile communication, WiMAX or CATV coaxial cable.

The term “display device” as used herein includes but is not limited to a TV, a computer screen or a projecting screen. According to the present invention, the display device may also display options of different functions in a form of a square or rectangular array to provide interactive services and functions.

In one embodiment of the present invention, the mediation module may be integrated in the display device. In another embodiment, the mediation module may be independent from the display device. According to one embodiment of the present invention, the mediation module is a set-up box, a universal serial bus (USB) device, or a mobile device, wherein the mediation module may communicate with the server unit through internet.

In one embodiment of the present invention, the mediation module comprises a built-in media access control address (MAC address) for passing certification of the server unit.

According to the present invention, the remote module transmits commands or information to the display device or the mediation module through transmission mediums such as infrared rays (IR), radio frequency (RF), wireless fidelity (Wi-Fi) or other suitable transmission mediums.

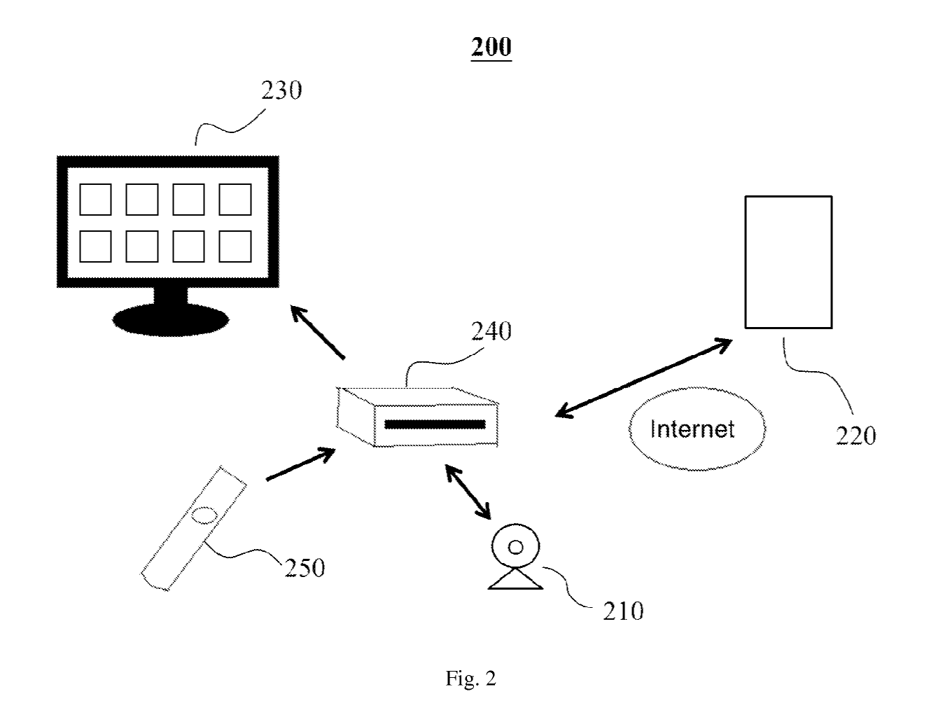

FIG. 2 illustrates an embodiment of the present invention, a multimedia system 200 for displaying an electronic personalized menu, wherein the multimedia system provides a plurality of services for one or more users, wherein each of the plurality of services includes one or more service options/items, the multimedia system comprising: a recognition data detection module 210 for detecting a recognition data for recognition of the identity and number of the one or more user, the recognition data detection module being able to communicate with the below mentioned mediation module 240; a server unit 220 configured to, upon execution of computer readable instructions: automatically logging into a personal or group account based on the identity and number of the one or more users; recording use habits of the one or more users of the personal or group account; and generating an electronic personalized menu of the personal or group account based on the use habits recorded; a display device 230 for displaying the plurality of services and the electronic personalized menu; a mediation module 240 connected between the display device 230 and the server unit 220; and a remote control module 250 for inputting instructions to the mediation module; wherein the recognition data is processed by the mediation module 240 and then transmits to the sever unit 220 for certification and automatic recognition of the identity and number of the one or more users by a recognition method.

In one embodiment of the present invention, the multimedia system provides k services having Nₖ orders of service options respectively, wherein there are one or more n^{th} order service items and/or one or more n+1^{th} order service options under a n^{th} order service option of the Nₖ orders of service options, wherein n is a natural number and 1≦n≦N^{k}, the method comprising: recording the one or more users' use frequency of each n^{th} order service option and item in a recent period of time, wherein n is a natural number and 1≦n≦N^{k}; and presenting to the one or more users a n^{th} order menu of a service, the n^{th} order menu comprising: (i) one or more n^{th} order service items and/or one or more n+1^{th} order service options of the service which are sorted according to the use frequency thereof, wherein a n+1^{th} order service menu is presented when a n+1^{th} order service option is selected; or (ii) one or more n+1^{th} order service items of one or more n+1^{th} order service options of the service, wherein the one or more n+1^{th} order items are sorted according to the use frequency thereof, wherein n is a natural number and 1≦n<N^{k}; wherein k and N^{k} are natural numbers and k>N^{k}≧1.

In one preferred embodiment of the present invention, each service item corresponding to each service menu is presented in a menu in the form of a square or rectangular array. According to one embodiment of the present invention, the menu in the form of a square or rectangular array may be 3-by-3 square array or a 4-by-3 rectangular array.

Based on the above descriptions, the present invention is not limited to the preferred embodiment described herein and those skilled in the art may make various changes and modifications to the present invention while not deviating from the spirit and scope thereof, wherein the changes and modifications are included in the claims of the invention.

What is claimed is:

1. A machine-implemented method of displaying an electronic personalized menu applied for a multimedia system, wherein the multimedia system provides a plurality of services for one or more users, wherein each of the plurality of services includes one or more service options/items, and the multimedia system comprises a sever, the method comprising:
detecting recognition data corresponding to the one or more users and recognizing the identity and number of the one or more users by a recognition method;
automatically logging into a personal or group account based on the identity and number of the one or more users and then the sever recording use habits of the one or more users of the personal or group account; and
displaying an electronic personalized menu of the personal or group account based on the use habits recorded.

2. The machine-implemented method of claim 1, wherein the electronic personalized menu presents one or more service items sorted according to use frequency of the one or more service options/items in a recent period of time.

3. The machine-implemented method of claim 1, wherein the electronic personalized menu presents one or more recommended service options/items or advertisements based on the use habits recorded.

4. The machine-implemented method of claim 1, wherein the recognition method is selected from the group consisting of image recognition, iris recognition, voiceprint recognition, fingerprint recognition, and a combination thereof.

5. The machine-implemented method of claim 2, wherein the recent period of time may be between one to ninety days.

6. The machine-implemented method of claim 1, wherein the service presents an item selected from the group consisting of personalized channels, personalized movies, personalized albums, personalized guestbooks, personalized internet videos, and a combination thereof.

7. The machine-implemented method of claim 1, wherein the multimedia system provides k services having Nₖ orders of service options respectively, wherein there are one or more n^{th} order service items and/or one or more n+1^{th} order service options under a n^{th} order service option of the Nₖ orders of service options, wherein n is a natural number and 1≦n≦N^{k}, the method comprising:
recording the one or more users' use frequency of each n^{th} order service option and item in a recent period of time, wherein n is a natural number and 1≦n≦N^{k}; and
presenting to the one or more users a n^{th} order menu of a service, the n^{th} order menu comprising: (i) one or more n^{th} order service items and/or one or more n+1^{th} order service options of the service which are sorted according to the use frequency thereof, wherein a n+1^{th} order service menu is presented when a n+1^{th} order service option is selected; or (ii) one or more n+1^{th} order service items of one or more n+1^{th} order service options of the service, wherein the one or more n+1^{th} order items are sorted according to the use frequency thereof, wherein n is a natural number and 1≦n<N^{k};
wherein k and N^{k} are natural numbers and k>N^{k}>1.

8. The machine-implemented method of claim 7, wherein the n+1^{th} order menu comprises:
(i) one or more n+1^{th} order service items and/or one or more n+2^{th} order service options of the service which are sorted according to the use frequency thereof, wherein a n+2^{th} order service menu is presented when a n+2^{th} order service option is selected; or (ii) one or more n+2^{th} order service items of one or more n+2^{th} order service options of the service, wherein the one or more n+2^{th} order items are sorted according to the use frequency thereof, wherein n is a natural number and 1≦n<N^{k}−1.

9. The machine-implemented method of claim 7, wherein when the service is a TV program service, a 1^{st} order menu of the service may be presented, the 1^{st} order menu comprising one or more 2^{nd} order service options which are sorted according to the use frequency thereof, wherein a 2^{nd} order menu is presented when a 2^{nd} order service option is selected.

10. The machine-implemented method of claim 9, wherein the one or more 2^{nd} order service options are selected from the group consisting of news program, featured program, entertainment program, sport program, religion program, live program, worldwide program, digital broadcast TV program, drama program, movie, political program, health program, science program, education program, culture program, food program, travel program, art program, music program, and a combination thereof.

11. The machine-implemented method of claim 1, wherein the one or more service options/items are presented in a menu in the form of a square or rectangular array.

12. A multimedia system for displaying an electronic personalized menu, wherein the multimedia system provides a plurality of services for one or more users, wherein each of the plurality of services includes one or more service options/items, the multimedia system comprising:
a recognition data detection module for detecting a recognition data for recognition of the identity and number of the one or more user, the recognition data detection module being able to communicate with the below mentioned mediation module;
a server unit configured to, upon execution of computer readable instructions: automatically logging into a personal or group account based on the identity and number of the one or more users; recording use habits of the one or more users of the personal or group account;
and generating an electronic personalized menu of the personal or group account based on the use habits recorded;
a display device for displaying the plurality of services and the electronic personalized menu;
a mediation module connected between the display device and the server unit; and
a remote control module for inputting instructions to the mediation module;
wherein the recognition data is processed by the mediation module and then transmits to the sever unit for certification and automatic recognition of the identity and number of the one or more users by a recognition method.

13. The multimedia system of claim 12, wherein the server provides an electronic personalized menu presents one or more service items sorted according to use frequency of the one or more service items in a recent period of time.

14. The multimedia system of claim 12, wherein the server provides an electronic personalized menu comprising recommend service options/items or advertisements.

15. The multimedia system of claim 12, wherein the recognition method is selected from the group consisting of image recognition, iris recognition, voiceprint recognition, fingerprint recognition, and a combination thereof.

16. The multimedia system of claim 12, wherein the recognition data detection module is incorporated with the display device, the mediation module, or the remote control module.

17. The multimedia system of claim 12, wherein the mediation module is a set-up box, a universal serial bus (USB) device, or a mobile device.

18. The multimedia system of claim 12, which provides k services having Nₖ orders of service options respectively, wherein there are one or more n^{th} order service items and/or one or more n+1^{th} order service options under a n^{th} order service option, wherein n is a natural number and 1≦n≦N^{k}, and the server unit configured to, upon execution of computer readable instructions:
recording the one or more users' use frequency of each nth order service option and item in a recent period of time, wherein n is a natural number and 1≦n≦N^{k}; and
providing a n^{th} order menu of a service, the n^{th} order menu comprising: (i) one or more nth order service items and/or one or more n+1^{th} order service options of the service which are sorted according to the use frequency thereof, wherein a n+1^{th} order service menu is presented when a n+1^{th} order service option is selected; or (ii) one or more n+1^{th} order service items of one or more n+1^{th} order service options of the service, wherein the one or more n+1^{th} order items are sorted according to the use frequency thereof, wherein n is a natural number and 1≦n<N^{k};
wherein k and N^{k} are natural numbers and k>N^{k}≧1.
